(19) United States
(12) Patent Application Publication
(10) Pub. No.: US 2004/0179092 A1
(43) Pub. Date: Sep. 16, 2004

(54) Videoconferencing communication system

(76) Inventor: Donald A. LaPoint, St. Louis, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/799,009

(22) Filed: Mar. 12, 2004

Related U.S. Application Data
(60) Provisional application No. 60/454,818, filed on Mar. 14, 2003.

(51) Int. Cl. H04N 7/14; H04M 11/04; H04L 12/66

(52) U.S. Cl. 348/14.08; 348/14.13; 379/45; 348/14.02

(57) ABSTRACT

A system and method for communicating with a plurality of emergency response persons is disclosed. A plurality of portable communication devices are provided for the emergency response persons. A central station including a video monitor and a video camera is in communication with a network. A plurality of remote stations including a video monitor and a video camera are also in communication with the network. The central station is in communication with the portable communication devices to provide a message to the emergency response persons. The remote stations are positioned for access by the emergency response persons. A router is in communication with the network for providing a bridged video connection between the central station and the remote stations. Emergency response persons located adjacent the remote stations are in video communication with each other and the central station. A system and method for providing medical advice from a remote location via video conferencing over a network to a plurality of locations where persons may need medical advice is also disclosed. Other systems and methods are also disclosed.

### BACKGROUND OF THE INVENTION

The present invention relates to an improved videoconferencing communication system and method for allowing personnel located throughout a geographic region to communicate with each other and a central station. In a conventional arrangement, emergency response workers and health care personnel often come together to face a crisis or moment of particular need from different regions and local governments. There will typically be a large number of different types of portable and fixed communication equipment available, but little ability for the users to communicate with each other and a central station for lack of compatibility among the different pieces of communications equipment. It is not unusual for different pieces of equipment to operate at different frequencies, data transmission rates, and other protocols which makes communication within the overall group very difficult. Since local governments have limited budgets, it is not practical to replace all of the equipment at once to achieve compatibility.

And given the general shortage of health care workers, it is important to expand their communication abilities so that fewer health care workers can provide a high level of health care across a broader area. In a conventional arrangement, for example in a school, it is not unusual to have one or more healthcare professionals per school to be available in the event a student becomes ill or is injured. During much of the day, such personnel may be underutilized. Then, if a serious problem occurs unexpectedly, such personnel may be overwhelmed and lack sufficient resources to handle the problem.

There is a need for an adaptive communication system to allow personnel located throughout a geographic region to communicate with each other and a central station using existing equipment. Such a system is needed for emergency personnel in responding to an emergency. Such a system is also needed by health care professionals to allow fewer health care professionals to service larger populations of customers spread out over potentially large geographic areas.

### SUMMARY OF THE INVENTION

Among the objects of the present invention are to provide an improved videoconferencing communication system and method which enables users spread throughout a geographic region to communicate with each other, to provide such an improved system and method which allows the users to communicate with each other and a central station, to provide such an improved system and method which allows users to communicate with communications equipment have different operating characteristics and protocols, and to provide such an improved system and method which is compatible with preexisting communications equipment.

Generally, one form of the invention is a system which communicates with a plurality of emergency response persons including a plurality of portable communication devices for the emergency response persons; a central station in communication with the network, the central station including a video monitor and a video camera; and a plurality of remote stations in communication with the network, the remote stations including a video monitor and a video camera. The central station is in communication with the portable communication devices to provide a message to the emergency response persons and the remote stations are positioned for access by the emergency response persons. A router in communication with the network provides a bridged video connection between the central station and the remote stations. Emergency response persons located adjacent the remote stations are in video communication with each other and the central station.

Another form of the invention is a method of responding to an emergency situation which includes the steps of providing a plurality of portable communication devices to a plurality of emergency response persons and directing the emergency response persons from a central station via the portable communication devices to travel to a remote station having a video communication device. The method further includes routing a communication from the video communication devices to provide a bridged video connection between the central station and the remote stations. Emergency response persons located adjacent the remote stations are in video communication with each other and the central station. The method may include providing a network having a bandwidth for passing the video communications between the remote stations and the central station, storing a bandwidth value for the remote stations, and determining an operating bandwidth value for each remote station as a function of the stored bandwidth value and of a bandwidth of at least a portion of the network between the remote stations and the central station.

Another form of the invention is a system for providing medical advice from a remote location via video conferencing to a plurality of locations where persons may need medical advice. Such a system can include a network, a program which assigns an identification mark for a plurality of persons who may need medical advice; and a database in communication with the network which stores medical data as a function of the identification marks concerning each of the plurality of persons who may need medical advice. Such a system also includes a medical station in communication with the network, the medical station being accessible to medical personnel, the medical station including a video monitor and a video camera and having access to the medical data in the database as a function of the identification marks. Such a system also includes a plurality of remote stations in communication with the network where the remote stations may have a video monitor and a video camera and may be located where persons may need medical advice. Such a system further has a circuit for initiating a medical help signal from a remote station and a router in communication with the network for providing a video connection between a medical station and a remote station in response to a medical help signal. The medical personnel at the medical station can review the medical data as a function of the identification marks in the course of providing medical advice via video conferencing to a person at a remote station.

Still another form of the invention is a method which provides medical advice from a remote location via video conferencing to a plurality of locations where persons may need medical advice. The method may include the steps of providing a network; assigning an identification mark for a plurality of persons who may need medical advice; and storing medical data as a function of the identification marks concerning each of the plurality of persons who may need medical advice. Such method also includes providing a medical station in communication with the network where the medical station is accessible to medical personnel and where the medical station includes a video monitor and a video camera having access to the medical data in the database as a function of the identification marks. Such method further includes providing a plurality of remote stations in communication with the network where the remote stations include a video monitor and a video camera located where persons may need medical advice. Such method further includes initiating a medical help signal from a remote station when medical advice is needed; providing a video connection between a medical station and a remote station in response to a medical help signal; and reviewing the medical data as a function of the identification marks in the course of providing medical advice via video conferencing to a person at a remote station.

Other objects and features will be in part apparent and in part pointed out hereinafter.

### BRIEF DESCRIPTION OF THE DRAWINGS

FIG. 1 shows a system and method for organizing a response by emergency personnel to an emergency.

FIG. 2 shows a system and method for providing medical advice from a remote location via video conferencing to a plurality of locations where persons may need medical advice.

Corresponding reference characters indicate corresponding features throughout the several views of the drawings.

### DETAILED DESCRIPTION OF PREFERRED EMBODIMENTS

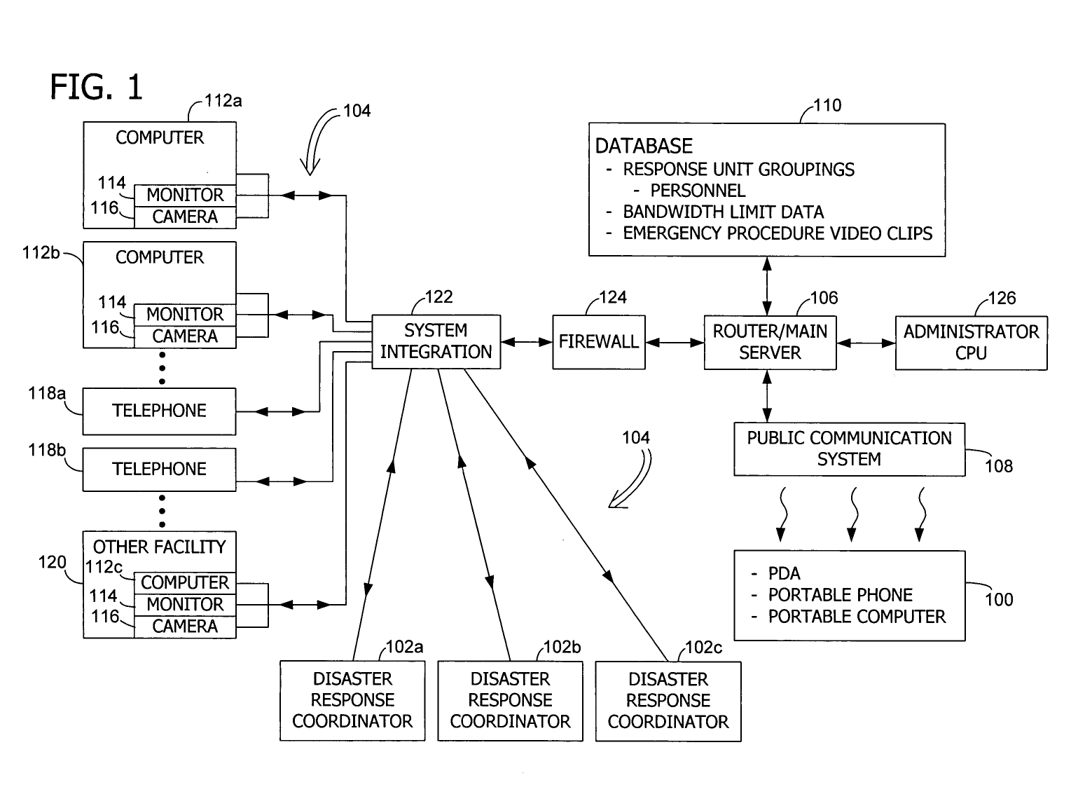

FIG. 1 shows a system and method for organizing a response by emergency personnel to an emergency. FIG. 1 includes a box 100 showing several types of portable communication devices which the emergency personnel would typically carry on their person. These portable devices take many forms and include the Personal Digital Assistant, portable telephone, and portable computer shown in box 100. Any type of portable communication device could be used within the scope of the invention.

In the event of an emergency, any of a number of disaster response coordinators (102a, 102b and 102c are shown by way of example, each with a video monitor and video camera) initiates an emergency message via a network 104. Network 104 can be a private network, wide area network, ethernet or any other suitable network include portions of the internet. The emergency message is received by a router/main server 106, which communicates the emergency message via public communication system 108 to the emergency personnel through portable devices 100. Different types of emergencies often require different types of persons in different locations. Thus, disaster response coordinator 102 has access to a database 110 in a memory which stores different response unit groups by personnel type and location. Coordinator 102 can thus select an appropriate particular personnel to respond to the emergency.

The emergency message might advise the emergency personnel to travel to their personal computers such as computers 112a and 112b to receive a fuller emergency message including a video presentation. Computers 112a and 112b could be located in the homes of the emergency personnel or at selected public or private locations 120. Computers 112 typically include a video monitor 114 and a video camera 116. Computers 112 are in video communication with the router/main server 106 via the network 104. Upon receiving the additional message, instructions or information via computers 112, the emergency personnel could then participate in a video conference with the coordinator 102 and other emergency personnel. Such conference might include a conventional discussion, might include video taken at the scene of the emergency, might provide particular instruction on how best to handle the emergency, and could include any other message, data or charts that might be helpful in the event of an emergency. Such conference might also include a viewing of one or more emergency procedure video clips stored in database 110 that are appropriate for the type of emergency then occurring. As an alternative to computer 112, the emergency personnel could use a telephone 118a or 118b having a built in video monitor and camera. By allowing for a plurality of remote stations in the form of computers 112, telephones 118, and portable devices 100 to communicate with a central station comprising coordinators 102(a-c) (who may or may not be geographically close together), the ability to communicate across large geographic areas to large numbers of emergency personnel is substantially enhanced over traditional forms of communication.

In order to maintain a robust network 104, computers 112 and telephones 118 may include a CODEC to receive and transmit data packets for processing the video signal. A system integrator 122 limits the bandwidth of the network 104 used by each of the remote stations so as maintain a suitable response time and video quality. The system integrator 122 prevents the transmitted or received packets of data from exceeding a predetermined bandwidth. The system integrator 122 will typically have access to a memory which stores a bandwidth value for the remote stations. The system integrator 122 is also programmed with bandwidth information for the portion of the network between the system integrator 122 and the remote stations. The system integrator 122 determines an operating bandwidth value for each remote station as a function of a bandwidth value stored in the memory and of a bandwidth of at least a portion of the network between the system integrator and the remote station. The system integrator thus communicates with each remote station 112, 118 and with coordinators 102 at a bandwidth rate calculated to take into account the particular bandwidth variables. The system integrator thereby allows for the use of different bandwidths and data feed rates for the different computers 112a, 112b, telephones 118a, 118b and coordinators 102a, 102b, 102c or any other communication devices.

In this manner, a divergent collection of hardware can be used at different rates and bandwidth values to communicate the same video message between and among the participants at the remote stations or through portable devices 100. In practice, the operating bandwidth value may be programmed to not exceed 100 kBytes per second for the remote stations. Alternatively, the operating bandwidth value may be programmed to not exceed 150 kBytes per second for the remote stations. For faster hardware and applications with greater bandwidth, the operating bandwidth value may be programmed to not exceed 400 kBytes per second for the remote stations, or even 1,000 kBytes per second for the remote stations.

A voice trigger circuit can also be used in some or all of the portable devices 100, computers 112a, 112b, telephones 118a, 118b and coordinators 102a, 102b, 102c for providing a voice signal as a function of whether a particular video camera outputs an audible signal. The router 106 then determines an image displayed on the video monitors as a function of the voice signal. Alternatively, some or all of the portable devices 100, computers 112a, 112b, telephones 118a, 118b and coordinators 102a, 102b, 102c may comprise circuitry for producing a data signal. The router 106 then determines an image displayed on the video monitors as a function of the data signal.

It is seen that the invention includes a method of responding to an emergency situation by providing a plurality of portable communication devices to a plurality of emergency response persons and directing the emergency response persons from a central station via the portable communication devices to travel to a remote station having a video communication device. By then routing a communication from the video communication devices to provide a bridged video connection between the central station and the remote stations, the emergency response persons located adjacent the remote stations are in video communication with each other and the central station as explained more fully herein with respect to the system shown in FIG. 1.

In order to maintain the security of the network 104, standard data encryption techniques are used. A portion of the network between a remote station (100, 112 or 118) and the central station 102 may comprise the internet. A portion of the network between two remote stations may also comprise the internet. The administrator CPU 126 is for normal system usage and maintenance.

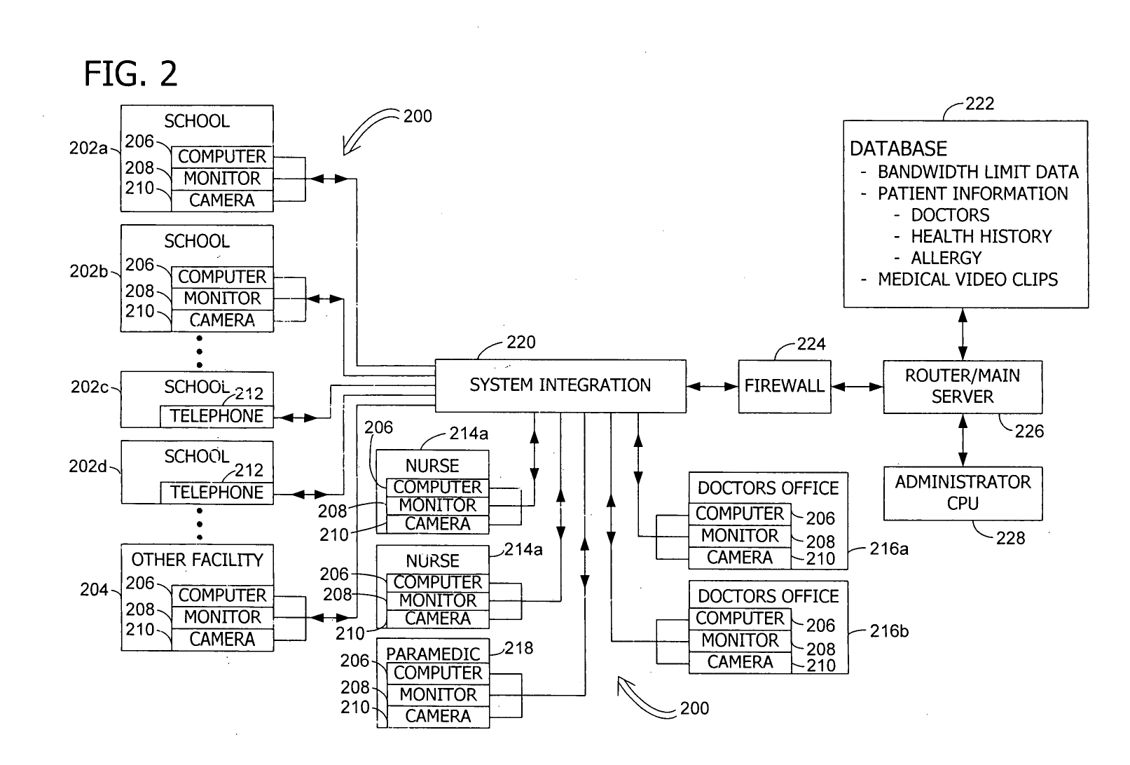

FIG. 2 shows a system and method for providing medical advice from a remote location via video conferencing to a plurality of remote locations where persons may need medical advice. Such a system could be used, for example, to provide a plurality of schools, parks, stadiums or any other areas where people meet with ready medical assistance at a relatively inexpensive cost. The medical personnel could be nurses, doctors, specialists, paramedics or other health care professionals. The system and method of FIG. 2 allow these increasingly scarce medical personnel to be available on short notice over broad geographic areas. And recognizing that a school, for example, may not need such medical advice for an extended duration, and then may need multiple medical personnel at other more critical times, the present invention allows for maximal utilization of available medical resources to provide medical advice to a large number of people at a reduced cost.

More particularly, FIG. 2 includes a network 200 which connects the whole system together and allows for orderly video communication. Network 200 can be a private network, wide area network, ethernet or any other suitable network include portions of the internet. Schools 202 and other facilities 204 are shown as the remote locations serviced by the system. Each of these remote locations may include a computer 206, video monitor 208 and video camera 210. Alternatively, these remote locations may have a telephone 212 equipped with a video camera and monitor for two way video communication. The other facility 204 is shown to have a computer 206, video monitor 208 and video camera 210; however, it could just as easily have a telephone 212 or other video conferencing equipment. Many more schools and facilities than those shown in FIG. 2 could be serviced by the invention. The only limits derive from available personnel and the capacity of the hardware used to construct the system. Video monitors at the remote locations to be served will typically include a circuit, such as an icon on a computer screen, which can be clicked on with a mouse to produce a medical help signal to establish immediate communication with the network 200 and other devices shown in FIG. 2.

FIG. 2 also includes a nurse 214, doctor's office 216, and paramedic 218 at still other remote medical locations. Each of these health care professionals has access to a computer 206, video monitor 208, video camera 210 for providing video-conferenced medical advice to a remote station 202, 204 via network 200. Alternatively, these health care professionals could have a telephone 212 or other video conferencing equipment.

The system integrator 220 has a similar function as the system integrator 122 in FIG. 1. That is, system integrator 220 controls the bandwidth usage by the remote stations 202, 204 and by the remote medical stations 214, 216, 218 with predetermined limits and calculations. In order to maintain a robust network 200, computers 206 and telephones 212 may include a CODEC to receive and transmit data packets for processing the video signal. A system integrator 220 limits the bandwidth of the network 200 used by each of the remote stations so as maintain a suitable response time and video quality. The system integrator 220 prevents the transmitted or received packets of data from exceeding a predetermined bandwidth. The system integrator 220 will typically have access to a memory in database 222 which stores bandwidth information for the remote stations, medical stations and network segments for use by the system integrator 220 in controlling bandwidth usage. The system integrator 220 determines an operating bandwidth value for each remote station as a function of a bandwidth value stored in the memory and of a bandwidth of at least a portion of the network between the system integrator and the remote station. The system integrator thus communicates with each remote station 202, 204 and with remote medical stations 214, 216, 218 at a bandwidth rate calculated to take into account the particular bandwidth variables. The system integrator thereby allows for the use of different bandwidths and data feed rates for the different computers 206 (whether located in a remote station or medical station), telephones 212 or any other communication devices.

In this manner, a divergent collection of hardware can be used at different rates and bandwidth values to communicate the same video message between and among the participants at the remote stations 202, 204 and/or remote medical stations 214, 216, 218. Thus, at least two remote stations 202, 204 can communicate with a remote medical station 214, 216, 218 at different operating bandwidth values. Similarly, at least two remote stations 202, 204 can communicate with each other at different operating bandwidth values. In practice, the operating bandwidth value may be programmed to not exceed 100 kBytes per second for the remote stations. Alternatively, the operating bandwidth value may be programmed to not exceed 150 kBytes per second for the remote stations. For faster hardware and applications with greater bandwidth, the operating bandwidth value may be programmed to not exceed 400 kBytes per second for the remote stations, or even 1,000 kBytes per second for the remote stations.

A voice trigger circuit can also be used in some or all of the computers 206 and telephones 212 for providing a voice signal as a function of whether a particular video camera outputs an audible signal. The router 226 then determines an image displayed on the video monitors as a function of the voice signal. Alternatively, some or all of the computers 206 and telephones 212 may comprise circuitry for producing a data signal. The router 226 then determines an image displayed on the video monitors as a function of the data signal.

Database 222 also stores medical data for the people who receive medical advice. For example, a student's past health history, immunizations, allergies, past accidents and injuries, etc., can all be stored in the database and available to the health care provider whenever medical advice is given. Database 222 might even be used to replace a person's traditional medical file. In this manner, it does not matter where a person is injured or needs medical advice. So long as a remote station can be found, the medical provider will be able to access the person's medical history and take it into account in providing medical advice. Database 222 may be organized using a program to assign an identification mark for the persons who will have their medical records stored in the database. As new medical information becomes available over time, such new information is associated with the identification mark and stored in the database. Whenever a health care professional then needs to render medical advise concerning the person, the person's identification mark can be used to access all of their medical data. Database 222 may also store medical data comprising a person's health care providers as a function of the identification marks. In this event, the router 226 provides a video connection between a medical station where such a health care provider may be found and the remote station where the person needing medical advice is located as a function of the stored medical data.

Database 222 may also include medical video clips showing various medical conditions to help in diagnosis or showing how to perform various medical steps or procedures by less trained persons at the remote stations. Any manner of medical information and advice can thus be stored and accessed in this way. The remote stations 202, 204 include programming for selecting a particular video segment for viewing at the remote station.

It is seen that the invention includes a method for providing medical advice from a remote location via video conferencing over a network to a plurality of other remote locations where persons may need medical advice. By assigning an identification mark for a plurality of persons who may need medical advice, then storing medical data as a function of the identification marks concerning each of the plurality of persons who may need medical advice, and then providing a medical station in communication with the network which has access to the medical data in the database as a function of the identification marks, such medical data is available to the medical personnel for their review at the time they need to provide the advice. Further, by providing a plurality of remote stations in communication with the network which are located where persons may need medical advice, such persons can initiate a medical help signal from a remote station to obtain medical advice over the network via a video connection between a medical station and the remote station. Operation of the system of FIG. 2 accomplishes this method and other features as described more fully herein.

The firewall provides security for the network 200 which also uses traditional encrypted data techniques for added security. A portion of the network between a remote station 202, 204 and a remote medical station 214, 216, 218 may comprise the internet. A portion of the network between two remote stations may also comprise the internet. The router/main server performs its traditional role in providing the functionality described above. The administrator CPU 228 is for normal system usage and maintenance.

The embodiments of the present invention described more fully above have been implemented using a Cisco Series Router and related equipment. The Cisco Series Router provides platform modularity and flexibility because it supports any WAN service such as leased lines, Integrated Services Digital Network (ISDN), Frame Relay, X.25, Switched 56 and Switched Multimegabit Data Service, and emerging services such as xDSL and Asynchronous Transfer Mode. The Cisco Series Router also provides end-to-end security and data privacy and supports a large variety of multimedia, multicast, voice integration, and other time-sensitive applications. It has enhanced internet/intranet access features which reduces cost and increases flexibility in protocol or address management, including Dial Virtual Private Networks. The Cisco Series Router also provides WAN optimization features to ensure the best use of available bandwidth and reduce recurring WAN line costs, including data compression.

The implementation further included the Cisco Catalyst Switch. Multi-service networking is emerging as a strategically important issue for enterprise and service provider infrastructures. The proposition of multiservice networking, or convergence, is the combination of all types of communications-data, voice and video-over one physical infrastructure. The benefits of multiservice networking include: Reduced operational costs, higher performance, greater flexibility, integration, and faster application and service deployment. Interest in convergence is fueled by short-term interest in cost savings, medium-term requirements for emerging application support, and long-term direction for complexity reduction and new application development. Multiservice networking brings immediate cost savings by allowing some portion of the telecom budget to be cross-utilized into the data or information systems budget. This is first achieved by consolidation in the wide-area network, where current costs are the highest. Most importantly, multiservice networking enables key emerging business applications by inherently supporting any type of traffic, and therefore, any type of network application requirements. Increasingly, emerging business applications such as unified voice and e-mail messaging, computer telephony integration, and desktop video streaming and videoconferencing require variable traffic types to be mixed in a reliable way, a scenario that can be achieved only by a true multiservice network.

The Cisco Catalyst family brings data, voice, and video integration onto the campus for fully integrated communications on every desktop. Campus multiservice networking provides voice support using the IP network infrastructure rather than the traditional PBX. This drastically increases the leverage of telephony spending into overall infrastructure spending, reduces capital and operational costs, and opens the environment to new innovation in telephony applications.

The Catalyst family of switches provides the capabilities required for robust telephony and seamless integration into one infrastructure. The Catalyst switches offer a broad range of connectivity options and network services. These systems deliver redundancy and topology resilience for the highest availability. They deliver multilayer, Gigabit/Fast Ethernet switching for the highest performance. Furthermore, these systems preserve voice quality by supporting advanced quality-of-service (QoS) mechanisms and intelligent switching features. As an integral part of the CiscoAssure policy networking architecture, Catalyst systems reduce network management complexity by removing the need for detailed parameter configuration. The Catalyst family offers the most complete campus solution in the industry for multiservice voice, video, and data networking.

The Catalyst family supports multiple levels of network resiliency and serviceability designed to handle mission-critical applications. To ensure high system availability, the Catalyst family supports device-level fault tolerance, including redundant: supervisors, load-sharing, power supplies (AC and DC), sharing fans, system clocks and uplinks. Further, all system elements, including power supplies, fans, supervisors, and line-card modules, are hot-swappable such that elements can be added, removed, or replaced without service interruption of unrelated traffic flows. In dual supervisor configurations, Cisco Switchover will transfer switch control to the redundant supervisor within seconds for mission-critical applications requiring maximum network availability. All system elements are also field-replaceable units, maximizing serviceability and minimizing network downtime. For network-level resilience, Catalyst family switches also support automatic recovery from failure using spanning tree per virtual LAN (VLAN), load sharing for faster link convergence using Cisco Fast EhterChannel® or Gigabit EhterChannel technology, and robust routing intelligence provided by Cisco IOS® software.

The Catalyst family of switches provides advanced network management features necessary for the success and maintenance of a multiservice infrastructure. A unique feature that demonstrates the advanced Cisco IP telephony leadership is the auxiliary VLAN feature. This feature provides automatic VLAN configuration for IP telephones. The auxiliary VLAN feature overcomes the complexity of overlaying a voice topology onto a data network. Network administrators can easily segment phones into separate logical networks, even though the data and voice infrastructure are physically the same. The auxiliary VLAN feature places the phones into their own VLANs without any end-user intervention. Furthermore, these VLAN assignments can be seamlessly maintained, even if the phone is moved to a new location. The user simply plugs the phone into the switch, and the switch will provide the phone with the necessary VLAN information. By placing phones into their own VLANs, network administrators gain the advantages of network segmentation and control. Furthermore, network administrators can preserve their existing IP topology for the data end stations. IP phones can be easily assigned to different IP subnets using standards-based dynamic host configuration protocol operation. With the phones in their own IP subnets and VLANs, network administrators can more easily identify and troubleshoot network problems. Additionally, network administrators can create and enforce QoS or security policies. With the auxiliary VLAN feature, Cisco enables network administrators to gain all the advantages of physical infrastructure convergence while maintaining separate logical topologies for voice and data terminals, creating the most effective way to manage a multiservice network.

The Catalyst family delivers a comprehensive set of management tools to provide the required visibility and control in the network. The Catalyst voice modules provide extended management capabilities, statistics, and status information for voice traffic. For instance, users can query the switch to see how many active calls exist. Users can also gather valuable management data about these calls, such as the source/destination module, port, and IP addresses. Centralized management is provided through CiscoWorks and the voice functions are administered from the CallManager.

CallManager is a web-based application that can be used to perform centralized configuration and management of the voice modules within the Catalyst family. Policy management is achieved through a combination of intelligent, embedded agents on the switches and CiscoWorks, a powerful network management application. CiscoWorks will provide policy management for all network services, including QoS, multicast, security, network resiliency, and mobility of users. Cisco Resource Manager is another Web-based management tool that offers automated inventory collection, software deployment, easy tracking of network changes, views into device availability, and quick isolation of error conditions.

Intelligent, embedded agents on Catalyst family switches include support for Discovery Protocol, delivering network topology discovery and mapping and virtual trunking protocol, and supporting dynamic VLANs and dynamic trunk configuration across all switches. Embedded intelligent Remote Monitoring (RMON) agents on every port deliver powerful traffic monitoring and control. Four RMON groups are supported per port to include statistics, history, events, and alarms groups.

The Catalyst family provides the performance, scalability, and intelligent services of AET IOS software for wiring-closet, enterprise backbone, and service provider applications. These switches can identify user applications-such as voice, enterprise resource planning, or multicast-and classify traffic with the appropriate priority level. They can support admission control in the wiring closet to prevent unauthorized applications from being allowed onto the network. The Catalyst family also supports advanced QoS features such as packet classification and marking, scheduling, policing and congestion avoidance.

Catalyst modules provide extensive per-port queuing to guarantee that voice traffic is given highest priority. Dedication voice queues can be configured such that QoS is maintained end to end through the switch and across the network. Network resilience features such as Layer 2 and Layer 3 load balancing, redundant system elements, and fast fail-over mechanisms maintain highest levels of system availability.

QoS policies are enforced using Layer 2, 3 and 4 IP Precedence and Layer 4 port numbers. Within Catalyst family switches, multiple queues with configurable thresholds employ weighted random early detection, weighted round robin, and type-of-service/class-of-service mapping mechanisms to ensure that QoS is maintained as packets traverse the network. Resource reservation protocol priority mapping can also be used, ensuring timely delivery of time-sensitive intranet applications.

Video distribution is defined by the user's requirements (e.g. H.323 Codec, H.320 Codec, PC/MPEG, etc). Video Conferencing is the ability to easily and seamlessly communicate across a WAN and public switched telephone network (PSTN) via Video Conferencing Codecs for the purpose of emergency broadcasts, meetings, conferences, and consultations.

A multipoint control unit (MCU) and advanced ESC gatekeeper provide complete functionality for Multipoint Video and Voice Conferencing and control for multimedia applications. MCU provides the highest video bandwidth performance over IP. MCU also provides from up to 100 ports (128K) or 70 ports (384K) and up to 2 MB video calls per card; video calls of up to 2 MB, the highest number of simultaneous conferences available on a single chassis; and the highest video call density in a single chassis. The MCU is powered by a 400 MHz processor using an ADSP chipset.

Various algorithms are used to achieve better audio quality levels at reduced bandwidth. Audio transcoding is used to accommodate endpoints that only support specific audio formats and to free up bandwidth on the LAN. The IP MCU supports the following audio codings: G.711 A Law and Laws, G.722, G.723, G.728 and G.729 A/B. A mix of these audio codings in the same conference is also supported. Audio Transcoding is provided via the IP MCU TCM: a PCI mezzanine card (PMC) implements multiprocessor Digital Signal Processing (DSP); the processing capacity is up to 30 channels for audio transcoding in video calls; and the processing capacity is up to 60 channels for audio transcoding in voice only calls.

The IP MCU Video Processing Server (VPS), version 2.0, performs rate matching, enabling each endpoint in a videoconferencing to participate according to individual video bandwidth capabilities without affecting the connection of other participants. The VPS also allows endpoints that are not capable of working in an asymmetrical mode to receive a symmetric media stream, allowing ISDN calls (passing via the Gateway) to receive a continuous presence video mode. The VPS will be provided as a server application, installed on a dedicated IP MCU board. The IP MCU supports specific voice conferencing features which include: exit/entry audio indications; interactive voice response; H.323 Fast-Start and empty capabilities set for VOIP endpoint support; DTMF detection; support for PSTN calls into a video conference via a Gateway; G.723 and G.729 audio transcoding; and a high capacity up to 150 voice calls on a single board. The inherent scalability of IP allows bandwidth to be increased, equipment to be added and services to be improved without making any fundamental changes to the underlying infrastructure. The MCU-card is also modular in its audio transcoding support making it a highly expandable solution.

he MCU fully supports the DCS add-on application server for enhanced conference capabilities by enabling full application sharing. This allows the user to view diagrams, graphic presentations and slide lectures simultaneously with other videoconferencing participants. It also allows the user to conduct text chats, whiteboard exchanges or rapid file transfers during a multipoint videoconference of three or more participants. The IP MCU DCS also supports T.120 data collaboration across a cascaded videoconference.

The continuous presence mode enables an enhanced and simultaneous view of conference participants in a four-window format. The format can be symmetrical or asymmetrical with up and down streams for optimal bandwidth utilization, and supports ADSL networks.

The IP MCU supports the bridging of several separate conferences to create very large conferences. It also permits the clustering of up to 4 IP MCU units, multiplying the number of concurrent conferences and the number of total available calls. On a cascaded configuration, the conference control for all participants in all conferences is available via the web interface. The IP MCU also provides a highly flexible distributed architecture that allows for the MCU, gateway or gatekeeper to physically reside in different locations allowing for full optimization of network traffic for high performance and high reliability.

An integrated conference scheduler manages conferencing, collaboration and meeting resources, including multiple time zone scheduling, attendee invitation, audio-visual requests and network resources. Ad-Hoc conferences can be instantly initiated from the end-point without any need to involve the MCU or through the conference control web interface. No per-conference configuration is necessary.

The MCU Web based administration and configuration tools can be accessed via any web browser using the IP MCU web administration screens. This provides easy access for both the conference administrator, the conference manager or the participants from any place on the network. Anytime, anywhere full monitoring and management support can be provided.

The MCU web interface allows the user to control and monitor a conference through a web browser. Conference participants have the ability to monitor conferences by viewing a conference control web page which displays the participant's names, phone numbers, terminal types, and basic conference settings. Conference control can be granted to authorized users allowing management activities such as locking the conference on a single participant, muting the audio of a specific participant, controlling continuous presence quadrant display and disconnecting participant terminals using the conference control. This is highly useful in conserving bandwidth when a participant has left the conference without disconnecting their terminal.

The Enhanced Communication Server (ECS), is an easy-to-use, advanced ITU-T, H.323 gatekeeper application that is essential for the management of IP telephony and multimedia communication networks. Network managers set policies and control network resources, such as bandwidth usage, to ensure optimal implementation. The ECS is a flexible, scalable gatekeeper application that can accommodate growing needs in a changing and expanding networking environment. Designed to provide necessary performance for small, medium and large V²oIP™ networks, from enterprise to service provider, the ECS gatekeeper can support up to 500 concurrent calls and 3000 registrations.

IP telephony was deployed as the core telecommunications infrastructure. This equipment is the backbone for which all emergency communications are based. The endpoint devices are linked together utilizing a frame relay network.

CallManager is the software-based call-processing component of the enterprise IP telephony solution and is a product enabled by AVVID (Architecture for Voice, Video and Integrated Data). AET's CallManager software extends enterprise telephony features and capabilities to packet telephony network devices such as IP phones, media processing devices, voice-over-IP (VOIP) gateways, and multimedia applications. Additional data, voice, and video services such as unfiled messaging, multimedia conferencing, collaborative contact centers, and interactive multimedia response systems interact with the IP telephony solution through CallManager's open telephony application programming interfaces. CallManager is installed on the media convergence server and selected third-party servers. CallManager software is shipped with a suite of integrated voice applications and utilities, including the WebAttendant, which is a software-only manual attendant console; a software-only conferencing application; the bulk administration tool; the CDR analysis and reporting tool; and the Admin Serviceability Tool.

AET's CallManager provides a scalable, distributable, and highly available enterprise IP telephony call-processing solution. Multiple CallManager servers are clustered and managed as a single entity. CallManager clustering yields scalability of up to 10,000 users per cluster. By interlinking multiple clusters, system capacity can be increased to as many as one million users in a 100-site system. Clustering aggregates the power of multiple, distributed, CallManagers, enhancing the scalability and accessibility of the servers to phones, gateways, and applications. Triple call-processing server redundancy improves overall system availability.

The benefit of this distributed architecture is improved system availability and scalability. Call admission control ensures that voice quality of service (QoS) is maintained across constricted WAN links, and automatically diverts calls to alternative PSTN routes when WAN bandwidth is not available. A web-browsable interface to the configuration database enables remote device and system configuration. HTML-based online help is available for users and administrators.

Enhancements in CallManager include: client user interface internationalization and localization; auto-answer at destination IP phone's speaker, enabling hands-free intercom service; host-based intrusion detection system certification; virus checker certification; H.323 performance improvement, enabling 1000 H.323 calls per server in a cluster; Cisco analog telephone adapter, ATA-186 integration; MGCP protocol extensions, including T1/E1 PRI and T1-CAS; Cisco Catalyst® access gateway switch; Cisco Catalyst access gateway module; Cisco multiservice routers; drop last conference party; WebAttendant consult transfer; message waiting indication (MWI) enhancements; MWI light enable/disable per line; voice-mail mailbox info delivery per line; support for new products; Cisco line extender device; and Cisco analog phone gateway.

A unified Unity messaging system was also employed. This provides a browser-based message access console for a dedicated voice mail inbox that delivers unified messaging functionality regardless of the groupware environment. The unified Unity messaging system is fully localized in U.S., English, French, German, and Japanese, including system prompts, subscriber conversations, browser-based administration consoles, and product documentation. Localized telephone system prompts are also available in multiple languages, including three dialects of English (Australian, New Zealand, and U.K.), Dutch, Italian, Mandarin Chinese, Norwegian, two dialects of Spanish (Colombian and European), and Swedish. E-mail, voice, and fax messages are organized in an e-mail inbox, giving centralized communications control. Voice and fax messages can be accessed from a desktop PC, laptop computer with modem using the Internet, or any touchtone telephone. A text-to-speech module reads e-mail messages over the telephone in clear, spoken English. Voice and fax messages can also be sent to anyone who can receive internet e-mail. A VCR-style interface plays, rewinds, pauses, or fast forwards messages with a few mouse clicks. The user can also forward faxes to any fax machine from a touchtone telephone. A browser-based personal administration ActiveAssistant makes it easy to customize the message notification option, allowing quick response to messages. Compound messaging capability gives the option to combine different media (for example, attach a Word file to a voice message) in a single message. All message types can be down-loaded for an off-line response or to create new messages off line. Voice and fax messages can be saved along with e-mail in public or personal Microsoft Exchange/Outlook folders for a complete record of all communications. Microsoft Exchange's inbox assistant rules apply to voice and fax mail. Thus, with Unity unified messaging, the user can see the number, type and status of all e-mail, voice and fax communications at a single glance. Unity gives subscribers the ability to customize their personal settings from the Internet Explorer 5.5 or higher using ActiveAssistant, a dynamic browser-based interface.

The IP Phone series is a standards-based communication appliance. The IP series phones can interoperate with IP telephony systems based on CallManager technology, H.323, or session initiated protocol and, in the future, media gateway control protocol, with system-initiated software updates. This multiprotocol capability provides investment protection and migration capability.

The IP Phone is a second-generation, full-featured IP phone primarily for high-level management deployment manager. It provides six programmable line/feature buttons and four interactive soft keys that guide a user through call features and functions. The IP Phone also features a large, pixel-based LCD display. The display provides features such as date and time, calling party name, calling party number, and digits dialed. The graphic capability of the display allows for the inclusion of present and future features.

The embodiment was constructed with the following Tandberg based equipment where video distribution was concerned. This equipment provides high quality, reliable and easy to use products that deliver excellent value. With these elements in mind, Tandberg has developed an extensive portfolio of standards-based products built on leading edge videoconferencing technology. Completely integrated, the system includes an LCD flat screen, codec, camera, microphone and speaker. With no external components or TV screen to worry about, its ultra thing frame can be hung on the wall or placed on a table.

Equipped with an intuitive on-screen user interface and automatically activated remote control, Tandberg products are designed for even the most non-technical of users. Setting up a videoconferencing call is as simple as making a telephone call—the user just dials the number and pushes the CONNECT button.

Video conferencing should be as natural as possible. Through intelligent call management TF, the equipment automatically configures itself to the best possible audio and video quality, guaranteeing the highest level of performance and the most natural of meeting environments, without the need for user intervention. Unlike traditional videoconferencing, Tandberg systems operate with native video resolutions. The images maintain their true resolution, rather than being scaled to adapt to various formats. This is of particular benefit to users of NTSC and SVGA resolutions.

The noise reduction feature ensures clear speech transmission by eliminating surrounding noise, even when the videoconference takes place in a noisy environment. In addition, automatic gain control ensures that no matter where individuals are located and regardless of the volume at which they speak, they will be heard at the same level at all remote sites. Even when the acoustic environment varies, the system is optimized to rapidly respond to these charges.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. A system for communicating with a plurality of emergency response persons comprising:
a plurality of portable communication devices for the emergency response persons;
a central station in communication with the network, the central station including a video monitor and a video camera;
a plurality of remote stations in communication with the network, the remote stations including a video monitor and a video camera;
wherein the central station is in communication with the portable communication devices to provide a message to the emergency response persons;
wherein the remote stations are positioned for access by the emergency response persons;
a router in communication with the network for providing a bridged video connection between the central station and the remote stations;
wherein emergency response persons located adjacent the remote stations are in video communication with each other and the central station.

2. The system of claim 1 wherein the network has a bandwidth and wherein the system further comprises:
a system integrator having access to a memory which stores a bandwidth value for the remote stations;
wherein the system integrator determines an operating bandwidth value for each remote station as a function of a bandwidth value stored in the memory and of a bandwidth of at least a portion of the network between the system integrator and the remote station.

3. The system of claim 2 wherein at least two of the remote stations communicate with the central station at different operating bandwidth values.

4. The system of claim 3 wherein the remote stations communicate with each other at different operating bandwidth values.

5. The system of claim 1 wherein the remote stations further comprise a CODEC coupled to a video camera for transmitting packets of data corresponding to an output of the video camera and for receiving packets of data provided to an input of the video monitor.

6. The system of claim 5 wherein the system integrator prevents the transmitted or received packets of data from exceeding a predetermined bandwidth.

7. The system of claim 6 wherein a portion of the network between a remote station and the central station comprises the internet.

8. The system of claim 7 wherein a portion of the network between two remote stations comprises the internet.

9. The system of claim 6 wherein a portion of the network between two remote stations comprises the internet.

10. The system of claim 5 wherein a portion of the network between a remote station and the central station comprises the internet.

11. The system of claim 1 wherein a remote station comprises a personal computer.

12. The system of claim 1 wherein a remote station comprises a telephone.

13. The system of claim 1 wherein the communications over the network are encrypted.

14. The system of claim 1 further comprising a voice trigger circuit for providing a voice signal as a function of whether a particular video camera outputs an audible signal; wherein the router determines an image displayed on the video monitors as a function of the voice signal.

15. The system of claim 1 further comprising circuitry for producing a data signal; wherein the router determines an image displayed on the video monitors as a function of the data signal.

16. A method of responding to an emergency situation comprising the steps of:
providing a plurality of portable communication devices to a plurality of emergency response persons;
directing the emergency response persons from a central station via the portable communication devices to travel to a remote station having a video communication device;
routing a communication from the video communication devices to provide a bridged video connection between the central station and the remote stations;
wherein emergency response persons located adjacent the remote stations are in video communication with each other and the central station.

17. The method of claim 16 further comprising the steps of:
providing a network having a bandwidth for passing the video communications between the remote stations and the central station;
storing a bandwidth value for the remote stations;
determining an operating bandwidth value for each remote station as a function of the stored bandwidth value and of a bandwidth of at least a portion of the network between the remote stations and the central station.

18. The method of claim 17 further comprising the step of operating at least two of the remote stations to communicate with the central station at different operating bandwidth values.

19. The method of claim 18 further comprising the step of operating at least two of the remote stations to communicate with each other at different operating bandwidth values.

20. The method of claim 16 further comprising the step of coupling a CODEC to a video camera in a remote station for transmitting packets of data corresponding to an output of the video camera and for receiving packets of data provided to an input of the video monitor at the remote station.

21. The method of claim 20 further comprising the step of preventing the transmitted or received packets of data from exceeding a predetermined bandwidth.

22. The method of claim 17 wherein the second providing step further comprises providing the internet as a portion of the network between a remote station and the central station.

23. The method of claim 22 wherein the second providing step further comprises providing the internet as a portion of the network between two remote stations.

24. The method of claim 16 wherein the directing step comprises directing the emergency response persons from a central station via the portable communication devices to travel to a personal computer having a video communication device.

25. The method of claim 16 wherein the directing step comprises directing the emergency response persons from a central station via the portable communication devices to travel to a telephone having a video communication device.

26. The method of claim 17 wherein the second providing step further comprises the step of providing a network having a bandwidth for passing encrypted video communications.

27. The method of claim 16 further comprising the steps of:
producing a voice signal as a function of whether a particular video camera outputs an audible signal; and
determining an image displayed on the video monitors as a function of the voice signal.

28. The system of claim 16 further comprising the steps of:
producing a data signal; and
determining an image displayed on the video monitors as a function of the data signal.

29. The system of claim 2 wherein the operating bandwidth value does not exceed 100 kBytes per second for the remote stations.

30. The system of claim 2 wherein the operating bandwidth value does not exceed 150 kBytes per second for the remote stations.

31. The system of claim 2 wherein the operating bandwidth value does not exceed 400 kbytes per second for the remote stations.

32. The system of claim 2 wherein the operating bandwidth value does not exceed 1,000 kbytes per second for the remote stations.

33. A system for providing medical advice from a remote location via video conferencing to a plurality of locations where persons may need medical advice, the system comprising:
a network;
a program for assigning an identification mark for a plurality of persons who may need medical advice;
a database in communication with the network for storing medical data as a function of the identification marks concerning each of the plurality of persons who may need medical advice;
a medical station in communication with the network, the medical station being accessible to medical personnel, the medical station including a video monitor and a video camera and having access to the medical data in the database as a function of the identification marks;
a plurality of remote stations in communication with the network, the remote stations including a video monitor and a video camera and being located where persons may need medical advice;
a circuit for initiating a medical help signal from a remote station;
a router in communication with the network for providing a video connection between a medical station and a remote station in response to a medical help signal;
wherein medical personnel at the medical station can review said medical data as a function of the identification marks in the course of providing medical advice via video conferencing to a person at a remote station.

34. The system of claim 33 wherein the database stores medical data comprising a person's medical history as a function of the identification marks and wherein medical personnel at the medical station can review said medical history as a function of the identification marks in the course of providing medical advice via video conferencing to such person at a remote station.

35. The system of claim 33 wherein the database stores medical data comprising a person's immunization record as a function of the identification marks and wherein medical personnel at the medical station can review said immunization record as a function of the identification marks in the course of providing medical advice via video conferencing to such person at a remote station.

36. The system of claim 33 wherein the database stores medical data comprising a person's health care providers as a function of the identification marks and wherein the router provides a video connection between a medical station where such a health care provider may be found and the remote station as a function of the stored medical data.

37. The system of claim 33 further comprising a memory in communication with the network for storing a plurality of video segments demonstrating a plurality of medical techniques or procedures, and wherein the remote stations include programming for selecting a particular video segment for viewing at the remote station.

38. The system of claim 33 wherein the network has a bandwidth and wherein the system further comprises:
a system integrator having access to a memory which stores a bandwidth value for the remote stations;
wherein the system integrator determines an operating bandwidth value for each remote station as a function of a bandwidth value stored in the memory and of a bandwidth of at least a portion of the network between the system integrator and the remote station.

39. The system of claim 38 wherein at least two of the remote stations communicate with the medical station at different operating bandwidth values.

40. The system of claim 39 wherein the remote stations communicate with each other at different operating bandwidth values.

41. The system of claim 33 wherein the remote stations further comprise a CODEC coupled to a video camera for transmitting packets of data corresponding to an output of the video camera and for receiving packets of data provided to an input of the video monitor.

42. The system of claim 41 wherein the system integrator prevents the transmitted or received packets of data from exceeding a predetermined bandwidth.

43. The system of claim 42 wherein a portion of the network between a remote station and the medical station comprises the internet.

44. The system of claim 43 wherein a portion of the network between two remote stations comprises the internet.

45. The system of claim 42 wherein a portion of the network between two remote stations comprises the internet.

46. The system of claim 41 wherein a portion of the network between a remote station and the medical station comprises the internet.

47. The system of claim 33 wherein a remote station comprises a personal computer.

48. The system of claim 33 wherein a remote station comprises a telephone.

49. The system of claim 33 wherein the communications over the network are encrypted.

50. The system of claim 33 further comprising a voice trigger circuit for providing a voice signal as a function of whether a particular video camera outputs an audible signal; wherein the router determines an image displayed on the video monitors as a function of the voice signal.

51. The system of claim 33 further comprising circuitry for producing a data signal; wherein the router determines an image displayed on the video monitors as a function of the data signal.

52. The system of claim 38 wherein the operating bandwidth value does not exceed 100 kBytes per second for the remote stations.

53. The system of claim 38 wherein the operating bandwidth value does not exceed 150 kBytes per second for the remote stations.

54. The system of claim 38 wherein the operating bandwidth value does not exceed 400 kBytes per second for the remote stations.

55. The system of claim 38 wherein the operating bandwidth value does not exceed 1,000 kBytes per second for the remote stations.

56. A method for providing medical advice from a remote location via video conferencing to a plurality of locations where persons may need medical advice, the method comprising the steps of:
providing a network;
assigning an identification mark for a plurality of persons who may need medical advice;
storing medical data as a function of the identification marks concerning each of the plurality of persons who may need medical advice;
providing a medical station in communication with the network, the medical station being accessible to medical personnel, the medical station including a video monitor and a video camera and having access to the medical data in the database as a function of the identification marks;
providing a plurality of remote stations in communication with the network, the remote stations including a video monitor and a video camera and being located where persons may need medical advice;
initiating a medical help signal from a remote station when medical advice is needed;
providing a video connection between a medical station and a remote station in response to a medical help signal;
reviewing said medical data as a function of the identification marks in the course of providing medical advice via video conferencing to a person at a remote station.

57. The method system of claim 56 wherein the storing step comprises storing a person's medical history as a function of the identification marks and wherein the reviewing step comprises reviewing said medical history as a function of the identification marks in the course of providing medical advice via video conferencing to such person at a remote station.

58. The method system of claim 56 wherein the storing step comprises storing a person's immunization record as a function of the identification marks and wherein the reviewing step comprises reviewing said immunization record as a function of the identification marks in the course of providing medical advice via video conferencing to such person at a remote station.

59. The method system of claim 56 wherein the storing step comprises storing a person's health care providers as a function of the identification marks and wherein the fourth providing step comprises providing a video connection between a medical station where such a health care provider may be found and the remote station as a function of the stored medical data.

60. The method of claim 56 further comprising the steps of:
storing a plurality of video segments demonstrating a plurality of medical techniques or procedures; and
selecting a particular video segment for viewing at a remote station.

61. The method of claim 56 further comprising the steps of:
providing a network having a bandwidth for passing the video communications between the remote stations and the medical station;
storing a bandwidth value for the remote stations;
determining an operating bandwidth value for each remote station as a function of the stored bandwidth value and of a bandwidth of at least a portion of the network between the remote stations and the medical station.

62. The method of claim 61 further comprising the step of operating at least two of the remote stations to communicate with the medical station at different operating bandwidth values.

63. The method of claim 62 further comprising the step of operating at least two of the remote stations to communicate with each other at different operating bandwidth values.

64. The method of claim 56 further comprising the step of coupling a CODEC to a video camera in a remote station for transmitting packets of data corresponding to an output of the video camera and for receiving packets of data provided to an input of the video monitor at the remote station.

65. The method of claim 64 further comprising the step of preventing the transmitted or received packets of data from exceeding a predetermined bandwidth.

66. The method of claim 61 wherein the fifth providing step further comprises providing the internet as a portion of the network between a remote station and the medical station.

67. The method of claim 62 wherein the fifth providing step further comprises providing the internet as a portion of the network between two remote stations.

68. The method of claim 61 wherein the fifth providing step further comprises the step of providing a network having a bandwidth for passing encrypted video communications.

69. The method of claim 56 further comprising the steps of:
producing a voice signal as a function of whether a particular video camera outputs an audible signal; and
determining an image displayed on one of the video monitors as a function of the voice signal.

70. The system of claim 56 further comprising the steps of:
producing a data signal; and
determining an image displayed on one of the video monitors as a function of the data signal.

71. The system of claim 33 further comprising a plurality of medical stations located in a plurality different locations.
